(19) United States
(12) Patent Application Publication
(10) Pub. No.: US 2026/0165338 A1
(43) Pub. Date: Jun. 18, 2026

(54) BREWING BEVERAGE MIXTURE WITHIN A SINGLE-SERVE POD WITH EXCESSIVE PRESSURE

(71) Applicants: Sung Oh, Chino Hills, CA (US); Masanori Shirakata, Torrance, CA (US); Shigeki Kato, Shizuoka (JP)

(72) Inventors: Sung Oh, Chino Hills, CA (US); Masanori Shirakata, Torrance, CA (US); Shigeki Kato, Shizuoka (JP)

(73) Assignee: DivergentIP, LLC, Beverly Hills, CA (US)

(21) Appl. No.: 19/344,019

(22) Filed: Sep. 29, 2025

Related U.S. Application Data
(60) Provisional application No. 63/719,090, filed on Nov. 11, 2024.

(51) Int. Cl. A23F 3/14; A23F 3/18; B65D 85/804

(52) U.S. Cl. CPC A23F 3/14; A23F 3/18; B65D 85/8067

(57) ABSTRACT

The method and system are adapted to brew a matcha beverage into a single-serve pod where the beverage mixture has excess pressure during the brewing process. The beverage mixture includes matcha powder and tencha, where the tencha does not affect the taste of the matcha because the tencha is the precursor to making the matcha by grinding the tencha to make matcha powder. The tencha is coarser than matcha powder, so that the water may flow through the beverage mixture to reduce the pressure. Alternatively, sugar may be incorporated into the beverage mixture to increase the extraction of the matcha. The water flow rate through the pod may be lowered from the beginning to the end of the brewing process, so that the later cycle of the brewing process may have a lower pressure.

### 1. RELATED APPLICATION

This application claims priority to U.S. Provisional Application Ser. No. 63/719,090, filed Nov. 11, 2024, entitled “Brewing Beverage Mixture Within A Single-Serve Pod with Excessive Pressure,” which is hereby incorporated by reference in its entirety.

### BACKGROUND OF THE INVENTION

### 2. Field of the Invention

This invention relates generally to beverage preparation systems, and more particularly to compositions and brewing methods that reduce internal pressure in single-serve pods containing fine beverage powders such as matcha.

### 3. Background of the Invention

The following background discussion does not imply that the matters discussed below are citable as prior art or common general knowledge. Rather, the general background information disclosed herein describes the problem(s) associated with the current state of the art and the need for a better solution.

Conventional single-serve beverage machines are designed primarily for brewing coffee and espresso. However, consumers are increasingly interested in alternative beverages, including matcha, sweetened drinks, and beverages served both hot and cold. Matcha poses specific challenges for these systems. Unlike coffee, matcha is made from finely ground tea leaves that do not dissolve but are suspended in water. Matcha powder has a particle size of approximately 5 to 20 microns, which may clog pod outlets and increase internal brewing pressure. This can result in poor flow, inconsistent beverage quality, or pod malfunction.

Furthermore, cold matcha beverages are difficult to prepare using conventional single-serve systems, which rely on hot water. Users often add ice to hot-brewed matcha, but this dilutes the beverage. Accordingly, there is a need for a method and composition that enables the efficient brewing of fine powders like matcha in single-serve pods without generating excessive pressure.

### 3. INVENTION SUMMARY

One of the aspects of the invention is a method of brewing a beverage mixture within a single-serving pod where the beverage mixture has excessive pressure during the brewing process, the method comprising: providing the beverage mixture where the first ingredient is an underlying beverage and a second ingredient that is coarser than the first ingredient, where the taste of the first ingredient is not substantially impacted by the second ingredient; inserting the beverage mixture into a single-serve pod; providing water into the single-serve pod where an average water temperature during the brewing process is greater than 140° F.; and

dividing a serving size of the signal-serve pod into several volume makers, where a flow rate of the first maker is higher than a last marker.

Another aspects of the invention is a matcha beverage composition for use in a single-serve pod, comprising: (a) 10-45% by weight matcha powder; and (b) 55-90% by weight tencha; wherein the tencha is coarser than the matcha powder, that do not substantially affect the taste of the matcha powder when the pod is brewed.

Another aspects of the invention is a matcha beverage composition for use in a single-serve pod, comprising: (a) 10-30% by weight matcha powder; (b) 15-40% by weight tencha; and (c) 40-70% by weight sugar; wherein the tencha and sugar are coarser than the matcha powder, which reduces the pressure within the pod when the pod is brewed.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1A shows a combination of matcha, tencha, and sugar.

FIG. 1B shows a tencha.

FIG. 1C shows a sugar.

FIG. 2 illustrates a flowchart of the brewing process for matcha.

FIG. 3A shows an upright expanded perspective view of a pod along a longitudinal axis.

FIG. 3B shows an inverted expanded perspective view of the pod of FIG. 3A.

FIG. 3C shows a cross-sectional view of the assembled pod without the beverage ingredient.

FIG. 3D shows a cross-sectional view of the assembled pod without the beverage in a brewing orientation.

FIG. 4A illustrates a cross-sectional view of the assembled pod with the beverage in a brewing orientation juxtaposition to the inlet member and the detached member.

FIG. 4B illustrates a cross-sectional view of the assembled pod with the beverage in a brewing orientation, where the inlet member is inserted and the extension member of the filter is detached by the detached member.

FIG. 4C illustrates that as the detached member moves further towards the inlet member, where a gap forms between the filter and the outer container, and the pressure in the beverage is about atmospheric pressure, as indicated by the meter.

FIG. 4D shows the inlet member injecting heated water into the cavity, and pressure is higher versus FIG. 4C.

FIG. 4E shows the inlet member stops injecting water into the pod, which indicates a low pressures from the meter.

FIG. 4F shows the inlet member again injecting water into the pod, which indicates a high pressure from the meter.

FIG. 5A illustrates a single-serve brewing system relative to the gravitational direction configured to adjust the water temperature, brewing time, and beverage-to-water ratio to brew various beverages.

FIG. 5B shows another embodiment of a single-serve brewing system.

FIG. 5C shows additional elements to FIG. 5B, where the single-serve brewing system may include a cooler element and an air pump.

FIG. 5D shows another embodiment of a single-serve brewing system, where the pod may be on a vertical axis.

FIG. 5E shows a modification of the K-Cup pods with the addition of support for the filter so that the filter may handle additional pressure within the filter.

### DETAILED DESCRIPTION OF THE INVENTION

The various aspects of the invention can be better understood with reference to the accompanying drawings and descriptions provided below. The components depicted in the figures are not necessarily to scale; rather, emphasis is placed on illustrating the principles of the invention. The claimed invention is not limited to apparatuses or methods having all of the features of any one example described, nor to features common to multiple or all described embodiments. The claimed invention may reside in combinations or sub-combinations of the apparatus elements or method steps described herein. It is possible that certain apparatuses or methods described are not examples of the claimed invention.

In general, the terms “may,” “is,” and “are” used as verbs throughout this disclosure express possibilities rather than mandatory conditions, in contrast to “shall” or “must.” For example, if the description states that a subject matter “may be” or “is” circular, this should be understood to encompass other shapes, such as oval, square, regular, irregular, or any other configurations known to those skilled in the art. Similarly, if a subject matter A “may be” or “is” adjacent to subject matter B, it includes the possibility that A is not adjacent to B, consistent with how a person of ordinary skill in the art would interpret such terms.

Furthermore, it is within the scope of the invention to combine different embodiments disclosed in connection with one or more drawings and their corresponding descriptions with one or more features from other drawings and descriptions disclosed herein, or from references incorporated by reference, provided such combinations are practicable to one of ordinary skill in the art.

The phrase “single-serve beverage pod” as used herein generally refers to a pod designed to brew a single serving of a beverage in one brewing cycle. However, within the scope of the invention, such pods may also contain enough beverage substance to brew multiple cups either through a single or multiple brewing processes.

The term “beverage substance” refers broadly to any material that, when mixed with a liquid such as water, forms a beverage. This includes, but is not limited to, coffee, tea, fruit drinks, punch, lemonade, soda, cocoa, milk, soup, energy drinks, liquid medicines, cannabis-based beverages, and the like. For example, a coffee beverage substance may consist of ground coffee, instant powdered coffee, or concentrated liquid coffee that is diluted with water. A tea beverage substance may consist of ground tea, instant tea powder, or concentrated tea in liquid form. In the case of baby milk, the beverage substance may be milk powder or concentrated liquid milk. For medicinal beverages such as flu or cold remedies, the beverage substance may be a powder or liquid that dissolves in heated water to form a consumable dose. Additionally, beverage substances may be provided in pellet form, infused with flavoring agents. When exposed to water, these pellets release their flavors into the liquid to create the final beverage.

Thus, beverage substances may exist in various forms—ground, powder, liquid, pellets, and others—and may be made from single or multiple ingredients. Throughout the disclosure, the same reference numerals generally correspond to the same or similar components across the various drawings and descriptions.

### Ingredients for Matcha

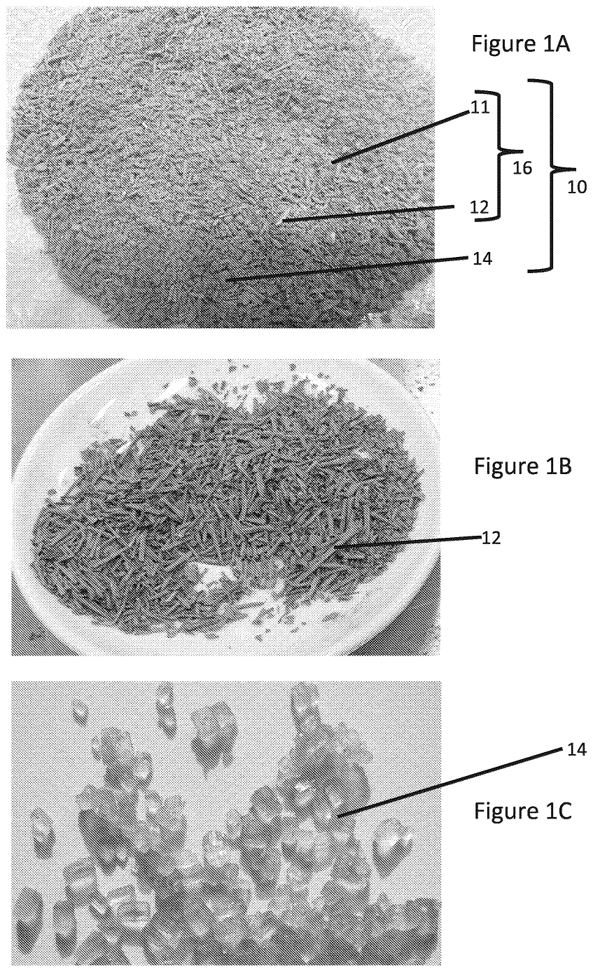

As discussed above, pure matcha powder may present challenges when dissolving in water within a single-serve pod. To address this issue, FIG. 1A illustrates a matcha mixture 10 that includes matcha powder 11, tencha 12, and optionally sugar 14. Specifically, the matcha combination 16 comprises matcha powder 11 and tencha 12. FIG. 1B shows an example of tencha 12 suitable for use in a single-serve beverage machine. The tencha 12 includes long stems that have not been milled into matcha powder prior to being placed into the pod. The longest tencha pieces may measure up to approximately 20 mm in length. When processed and dried, tencha 12 may assume a cylindrical or tubular shape with one or more longitudinal channels.

One function of incorporating tencha 12 into mixture 10 is to provide a coarser texture relative to matcha powder 11. This allows water to more easily infuse and extract the matcha while enabling the liquid to flow through the pod without excessive backpressure. The tencha 12, being coarser, tends to remain in the pod after brewing. The taste of matcha powder 11 may not be altered by the tencha 12 because the tencha 12 is the underlying substance to make fine matcha powder 11. That is, the taste of the matcha may be unaffected by the tencha because the tencha is the precursor to making the matcha. Other coarser ingredients that do not significantly alter the taste of matcha may also be used, such as expanded beads, plastic sleeves, bamboo fiber, oat hull fiber, sweet substances such as vanilla, strawberry powder, and similar substances.

Examples of matcha combination 16, comprising matcha powder 11 and tencha 12, include the following weight ratios: (1) approximately 10% to 45% matcha 11, and 55% to 90% tencha 12; (2) approximately 15% to 40% matcha 11, and 60% to 85% tencha 12; (3) approximately 20% to 35% matcha 11, and 65% to 80% tencha 12; and (4) approximately 25% to 30% matcha 11, and 70% to 75% tencha 12. Tencha is the raw tea leaf used to produce matcha, which is created by processing and drying tencha leaves before milling them into powder. Tencha typically has a pale green color, a deep and mellow flavor, and a subtle, lingering aroma. As tencha is the precursor to matcha, its inclusion in the mixture 10 does not substantially alter the flavor of the resulting matcha beverage.

FIG. 1A illustrates matcha mixture 10 after passing through an auger, which cuts tencha 12 into smaller pieces. Consequently, tencha may be shorter after augering. However, in some embodiments, tencha 12 may bypass the auger and retain its original length. When tencha 12 is cut via augering, the resulting particle size may range from about 1.0 mm to 10.0 mm, or more specifically, from about 3.0 mm to 8.0 mm, about 3.0 mm to 6.0 mm, or about 1.0 mm to 4.0 mm. The coarser nature of tencha and its longitudinal channels facilitates water flow through the pod to extract matcha 11. Note that the shorter the tencha 12 may have more pressure within the pod, and vice versa. The tencha 12 may also feature thin leaf-like structures with irregular, square, or rectangular shapes.

Testing indicates that adding sweeteners, such as brown sugar or pure cane turbinado sugar (referred to as sugar 14), enhances the extraction of matcha 11. FIG. 1C depicts sugar 14 used during testing. As sugar 14 is coarser than matcha powder, its inclusion in mixture 10 promotes water infiltration and improved extraction. The sugar 14 may be combined with matcha combination 16 in the following ratios: (1) 30% to 60% combination 16, and 40% to 70% sugar 14; (2) 35% to 60% combination 16, and 40% to 65% sugar 14; (3) 40% to 55% combination 16, and 45% to 60% sugar 14; (4) 45% to 55% combination 16, and 45% to 55% sugar 14; and (5) 45% to 50% combination 16, and 50% to 55% sugar 14. These ranges are selectable and are not cumulative.

In another example, matcha mixture 10 may include: (1) 10% to 30% matcha powder 11, 15% to 40% tencha 12, and 40% to 70% sugar 14; (2) 15% to 25% matcha powder 11, 20% to 35% tencha 12, and 45% to 60% sugar 14; and (3) 18% to 23% matcha powder 11, 20% to 30% tencha 12, and 45% to 55% sugar 14.

The actual weight of each ingredient will depend on the internal volume of the pod. For a 22 g pod, example formulations may include: (1) 2.0 g to 7.0 g matcha powder 11, 5.5 g to 10.0 g tencha 12, and 8.0 g to 14.0 g sugar 14; (2) 3.0 g to 6.0 g matcha powder, 6.5 g to 9.5 g tencha 12, and 8.5 g to 13.5 g sugar; (3) 3.5 g to 5.5 g matcha powder, 7.0 g to 9.0 g tencha 12, and 9.0 g to 13.0 g sugar; and (4) 4.0 g to 5.0 g matcha powder, 6.5 g to 8.5 g tencha 12, and 9.0 g to 12.5 g sugar. As tencha 12 is the precursor to matcha powder 11, it maintains flavor compatibility while providing a coarser structure for improved extraction.

In yet another example, matcha combination 16 (including matcha 11 power and the tencha 12) may be combined with sugar 14 in the following amounts: (1) 8.0 g to 20.0 g combination 16 and 5.0 g to 15.0 g sugar 14; (2) 8.0 g to 15.0 g combination 16 and 5.0 g to 12.0 g sugar 14; and (3) 10.0 g to 15.0 g combination 16 and 7.0 g to 12.0 g sugar 14. For example, with 4.0 g matcha, 9.0 g tencha, and 8.0 g sugar, the total weight is 21.0 g. The relative percentages are 19.0% matcha, 42.8% tencha, and 38.0% sugar. These proportions may vary depending on numerous factors.

Depending on pod size, the total weight of mixture 10 may range from 10.0 g to 25.0 g. For a 22.0 g formulation, a representative breakdown could be 20% matcha 11 (4.4 g), 25% tencha 12 (5.5 g), and 55% sugar 14 (12.1 g). Because not all matcha 11 may be extracted during brewing, an estimated 90% extraction yields may be 4.4 g×90%=3.96 g of matcha in the final beverage. Traditional matcha-to-water ratios recommend 2.0 g matcha per 70-80 g water (approximately 2.7 oz). If the default cup size of a single-serve brewer is 6 oz for matcha, the 4.0 g of matcha may be suited for a 6 oz cup size with a strong flavor. However, the weight and proportions of ingredients may vary based on cup size and desired strength.

### Flow Chart for High Pressure Ingredients

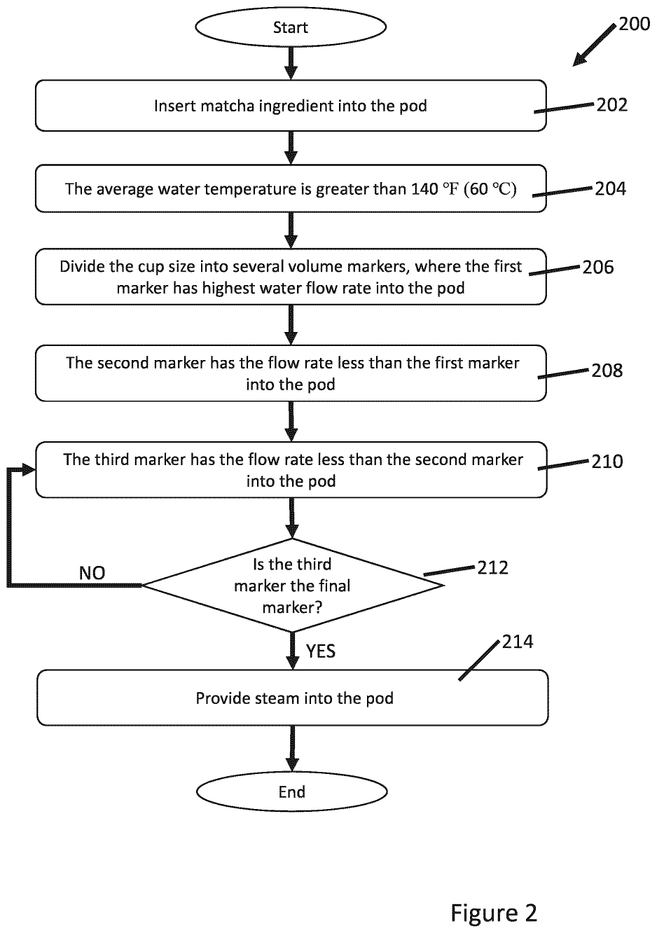

FIG. 2 illustrates a flow chart 200 for making a hotter beverage where the pressure within the pod may increase during brewing, such as Matcha. For example, there are many reasons why brewing Matcha utilizing single-serve beverage machines may be difficult. One is that the Matcha powder does not fully dissolve in water and may suspended in the liquid, and the Matcha particles may get stuck with the holes in the pod, restricting the beverage from exiting the pod. Restricting the flow may cause excessive pressure within the pod so that it will not work.

Step 202 is directed to inserting a Matcha ingredient 10 into a pod. The description of the pod element is below. The amount of the Matcha ingredient 10 may vary, and the percentages of the ingredients that make up the mixture, such as matcha, tencha, and sugar, may also vary depending on the strength of the Matcha and the volume (oz) of the cup. With a smaller volume, such as 4.0 oz, the tencha, and sugar may be less because the higher pressure may more likely occur with a higher volume, such as 6 oz and beyond.

Step 204 is directed to provide a temperature greater than 140° F. (60° C.). The average water temperature may be from 140° F. to 212° F., from 158° F. to 212° F., from 176° F. to 212° F., from 194° F. to 212° F., from 140° F. to 203° F., 140° F. to 194° F., 140° F. to 185° F., 140° F. to 167° F., or 140° F. to 158° F. Notably, increasing temperature may lead to increasing the pressure within the pod.

One way to resolve the excessive pressure within the pod is to progressively reduce the flow rates during the brewing process. Step 206 is directed to providing water flow to the pod with variable flow rates to the pod that provides the Matcha ingredient, where the cup size is divided into several volume markers. For example, if the selected cup is about 8 oz, there are many volume makers we can select: 1) two portions, 0 to 3.0 oz, and after the 3.1 to 8.0 oz; 2) three portions: 0 to 3.0 oz, 3.1 to 6.0 oz, and after the 6.1 to 8.0 oz; and 3) four portions: 0.0 to 2.0 oz, 2.1 to 4.0 oz, 4.1 oz to 6.0, and 6.1 to 8.0 oz. Also, Step 206 indicates that the first marker with a first flow rate may have the highest water flow rate compared to the rest of the marker(s). Having a faster flow rate may induce stirring of the matcha mixture 10 so that it may have more extraction, but the faster flow rate may lead to more pressure than the slower flow. With matcha, however, excessive pressure may occur later in the brewing process, so it is preferable to have a faster flow rate at the beginning because the matcha may get trapped in the holes of the pod in the later brewing process but not in the beginning. In Step 206, the first flow rate may be: 1) from 2.4 g/s to 4.5 g/s; 2) from 2.5 g/s to 4.4 g/s; 3) from 2.8 g/s to 4.4 g/s; and 4) from 3.0 g/s to 4.2 g/s. Note that the faster flow rate does not have to be at the beginning of the brewing process but not preferably at the end of the brewing process.

Step 208 is directed to a second marker with a second flow rate that may be less than the first. For the same example of having an 8 oz cup size, the second flow rate may be: 1) from 2.20 g/s to 3.6 g/s; 2) from 2.3 g/s to 3.4 g/s; 3) from 2.4 g/s to 3.2 g/s; and 4) from 2.6 g/s to 3.0 g/s. With the second flow rate being less than the first flow rate, the pressure within the pod would decrease.

Step 210 is directed to a third marker with a third flow rate that may be less than the second flow rate. For the same example of having an 8 oz cup size, the second flow rate may be: 1) from 1.8 g/s to 3.0 g/s; 2) from 2.0 g/s to 2.8 g/s; 3) from 2.2 g/s to 2.8 g/s; and 4) from 2.4 g/s to 3.0 g/s. The pressure within the pods may be high with the third flow rate later in the brewing process. To reduce the pressure, the third flow rate may be reduced than the first and second flow rates. Step 212, if the third flow rate is the final marker, then Step 214 provides steam air into the pod, which may flush out the remaining matcha beverage from the pod. Steam is water in the gas phase and, sometimes, also an aerosol of liquid water droplets or air. The steam air may penetrate the matcha mixture and extract the matcha without substantially increasing the pressure. The last steam air function may pour about 0.5 oz of the Matcha. If the answer to the decision block 212 is no, then the flow chart 200 will return to Step 210.

### Construction of Pod

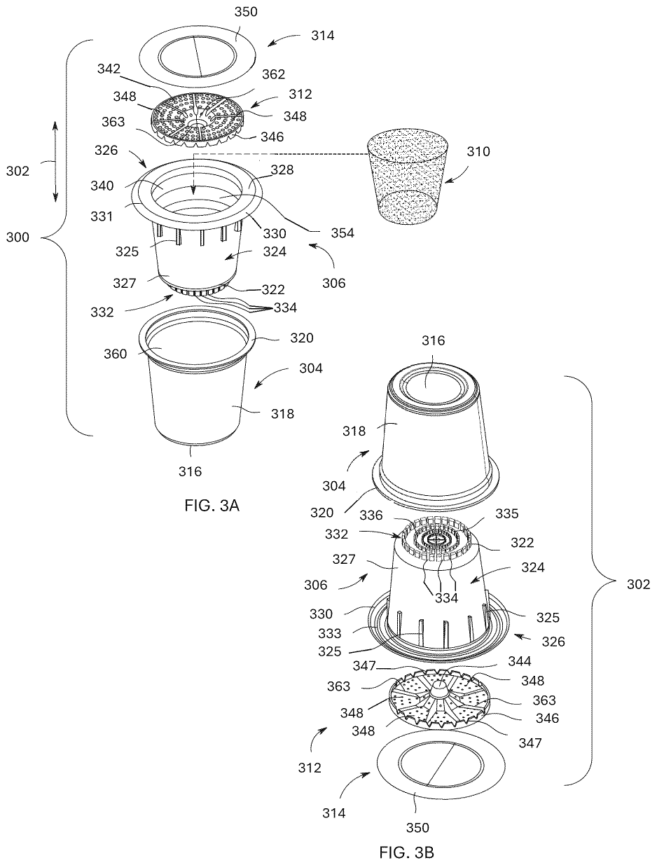

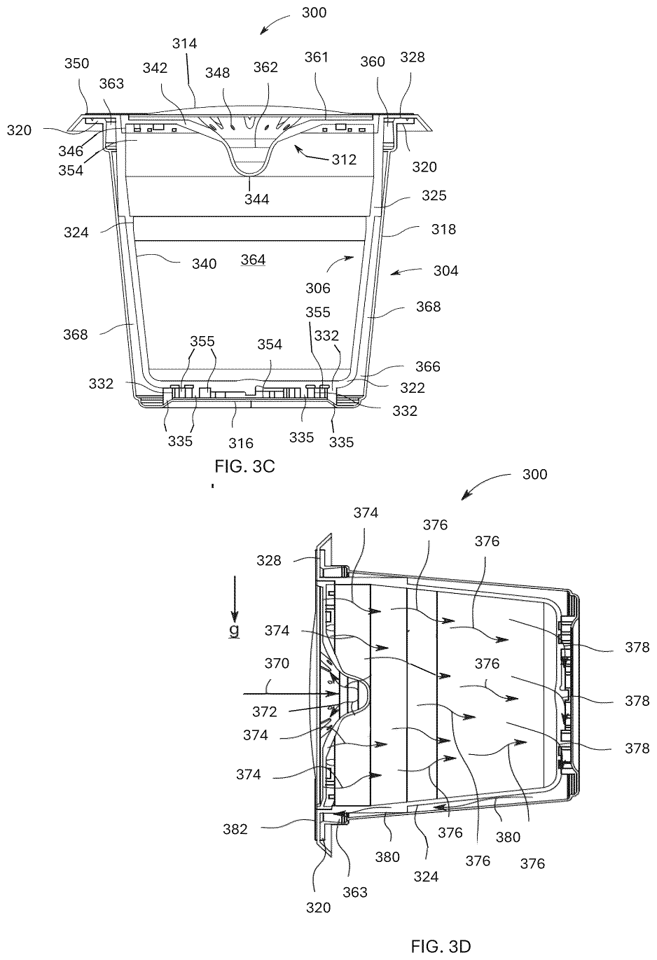

There are a variety of beverage systems to brew cold beverages, with the process related to FIGS. 1 and 2. For example, the following figures describe a mechanism similar to B-Pod®. FIG. 3A shows an upright expanded perspective view of a pod 300 along a longitudinal axis 302 configured to brew beverages such as coffee, espresso, tea, and matcha, and FIG. 3B shows an inverted expanded perspective view of the pod 300 along the axis 302 to show the top and bottom views, respectively, of the various components of the pod 300. The pod 300 may include a container 304, a filter 306 adapted to receive a beverage ingredient 310, a distributor 312, and a lid 314. The container 304 may have a base 316 that extends upwardly to form a sidewall 318 and then extends outwardly to form a rim 320 defining an opening 360. The container 304 may be formed from various materials and from single or multilayered sheets sandwiched together to form a hermetically sealed barrier to protect the beverage ingredients contained therein from atmospheric oxygen entering the container. The container may be formed from various materials known to one skilled in the art. In this regard, the container 304 may be formed in a manner described in U.S. Pat. No. 10,336,498 (the “'498 Patent”) issued Jul. 2, 2019, entitled “CONTAINER WITH IMPROVED PUNCTUREABILITY”, by Foster et al., which is hereby incorporated by reference in its entirety. In particular, the container 304 may be formed by a molding and thermoforming process of thermoplastic material, which may be substantially impermeable and imperforate. For example, the thermoplastic materials may include polyolefins such as polypropylene and polyethylene, polystyrene, nylon, and other polymers; in particular, the thermoplastic material may be a bio-based resin, readily recyclable, and/or comprise at least a portion of recycled material such as a recycled polypropylene base resin.

The filter 306 may have a base 322 that extends upwardly to form a sidewall 324 and then extends outwardly to form an extension 326, which may be defined by one or more sections, including a first section 328 and a second section 330. The first extension 328 may define an opening 354 adapted to receive the beverage ingredient 310. The first section may extend outwardly to a predetermined distance indicated by a reference numeral 331, and the second section 330 may extend farther therefrom outwardly in a beveled manner or downward sloping manner relative to the first section 328 towards the base 322. The extension 326 may have a line of weakness 333 between the first and second extensions 328 and 330 to allow the second extension 330 to weaken or separate from the first section 328 along the line of weakness 333, if desired. As discussed in more detail below, the line of weakness may allow the first section 328 to separate more readily from the rim 320 of the container. The first section 328 may extend outwardly at a distance, as indicated by the reference numeral 331, such that the first section 328 may extend farther out laterally than the rim 320 to allow the first section 328 to lay upon or overlap the rim 320 when the filter 306 is placed within the container 304. The base 322 of the filter 306 may have a plurality of holes 336 where the size and number of the holes 336 may be predetermined to control the flow of the beverage through the holes 336 to provide a desired pressure within the filter 306, as discussed in more detail below. The base 322 may also have at least one retainer wall 332 with a plurality of slits 334, as discussed in more detail below.

The container 304 may be adapted to receive the filter 306. The first section 328 of the extension 326 may be releasably sealed or adhered to the rim 320 of the container 304, whereupon a force is applied to the underside of the second section 330, the first section 328 may peel, separate, and snap off from the rim 320. Note that these terms may be used interchangeably in this application. In this regard, the releasable bond(s) may be utilized, such as the embodiments disclosed in US Published Application No. 2014/0161936, published Jun. 12, 2014, entitled CONTAINER WITH REMOVALE PORTION by Trombetta et al., which is hereby incorporated by reference in its entirety. Alternatively, the first section 328 of the filter 304 may be ultrasonically sealed to the rim 320 of the container 304, such as the torsional ultrasonic method, where high-frequency vibrations are applied tangentially as provided by Telsonic Ultrasonics Inc., located at 14120 Industrial Center Dr., Shelby Township, Michigan 48315 U.S.A.

The distributor 312 may have a base 342 with an outer flap 346 adapted to engage with the inner side 340 of the sidewall 324 of the filter 306 such that the base 342 may be adjacent to the first section 328 of the extension 326. The flap 346 may extend upwardly and downwardly to engage with the inner side 340 of the sidewall. The base 342 may have a protrusion 344 extending towards the inner space within the filter 306. The protrusion 344 may form a cavity 362 sized to receive an inlet liquid injection member, as discussed in more detail below, such as an inlet member to inject heated water into the filter 306. The base 342 may have a plurality of holes 348 to allow the heated water to pass therethrough to substantially distribute the water over the opening 354 of the filter 306. The size of the holes 348 may be less than the average size of the beverage ingredient 310. This may substantially prevent the beverage ingredient 310 from entering the protrusion area 344, thereby substantially preventing the beverage ingredient from clogging the inlet injection member, which can cause the brewing mechanism to malfunction.

The sidewall 324 may have one or more ribs 325 extending outwardly. The extending ribs 325 may be formed on the exterior side 327 of the sidewall 324 adjacent to the extension 326. As the filter 306 is inserted into the container 304, the extending ribs 325 may engage with the sidewall 318 of the container 304 to center the filter 306 relative to the container 304 such that the filter 306 may be substantially aligned with the filter 306 along the axis 302 of the pod 300. The distributor 312 may be placed over the beverage ingredient packed within the filter 306, and the flaps 346 may be engaged or sealed within the interior side 340 of the sidewall 324 of the filter 306 such that the beverage ingredient 310 may be substantially compact between the distributor 312 and the base 322. The distributor 312 may have a flange 346 with cutouts 347 around the circumference of the flange 346 to allow the outer area of the distributor 312 to flex and bend. The protrusion 344 may have an inverted bell-like shape to enlarge the area of the cavity 362 adapted to receive the inlet member of the brewing mechanism. The enlarged cavity 362 may also allow the outer area of the distributor 312 to flex and bend more readily.

The manner in which the beverage ingredient is packed within the filter 306 may be predetermined to control the density of the beverage ingredient 310 therein to substantially prevent air pockets, gaps, and channels from forming within the ingredient 310 during manufacturing, shipping, handling, and during the brewing process. As a general rule, beverage ingredient 310 with greater density may require more significant pressure to push the heated liquid through the beverage ingredient 310, which can extract more intense flavor from the beverage ingredient 310 in less time. Once the first section 328 of the filter 306 is separated from the rim 320, as discussed in more detail below, the distributor 312 may flex to substantially contain the ingredient 310 within the filter 306 to avoid forming air pockets therein. The lid 314 may be placed over the filter 306, and the outer edge 350 of the lid 314 may be sealed and/or bonded to the first section 328 of the filter 306. In particular, the lid 314 may be formed from a flexible liner with sufficient tensile strength to resist tearing due to high pressure during brewing.

The pressure developed within the beverage ingredient 310 can determine the type of beverage brewed, such as coffee under lower pressure and espresso under higher pressure. Several other factors can determine the pressure developed within the beverage ingredient 310, such as the pressure and temperature of the heated water injected into the beverage ingredient, the grind size and density of the beverage ingredient, the size and number of holes 336 in the base 322 of the filter 306, the depth of the beverage ingredient, etc. The base 322 may have a predetermined number of holes sized to allow the beverage to pass through but substantially prevent the beverage ingredient packed within the filter 306 from passing through the holes due to pressure within the filter during the brewing process. For instance, the sidewall 324 may be substantially solid to direct most of the beverage, if not all, to pass through the holes 336 on the base 322. Moreover, the stiffeners 325 extending from the sidewall 324 may substantially maintain their shape under the desired brewing pressure conditions. The number and/or size of the holes 336 formed in the base 322 may be predetermined to provide sufficient resistance to the beverage flow to develop the desired brewing pressure within the beverage ingredient to brew a desired beverage. For example, to brew espresso under high pressure from about 6 to 15 bars, the coffee beans may be finely grounded where the average grind size may be from about 40 to about 450 microns, and to brew coffee under low pressure from about 1 to 4 bars, the coffee may be grounded more coarsely where the average grind size may be from about 500 to about 1,000 microns; and to substantially prevent the grinds from passing through the holes, the size of the holes 336 may be less than the average grind size of the coffee grounds. The holes may have a variety of shapes, such as circular, square, rectangular, regular, and irregular configurations.

Along with the size of the holes 336, the number of holes 336 provided in the base 322 may be predetermined to develop the desired pressure within the filter 306 to brew the intended beverage, such as espresso or coffee. That is, the brewing mechanism may inject heated water into the pod 300 at a pressure of up to about 19 bars, but some of the pressure may be released through the coffee ground and through the filter 306 such that the espresso flavor beverage may be extracted from the finer coffee ground at about 8 bars, for example, with the difference of 11 bars of pressure being released, in this example. That is, the pressure within the filter may largely depend upon the size of the beverage ingredient and the size and number of holes 336. For instance, for low-pressure coffee, coarser ground coffee may be packed within the filter 306. The size and number of holes 336 may be greater than that of the holes 336 to brew espresso. Substantial pressure may be released through the coffee ground and through the filter 306 such that coffee may be extracted from the coarser coffee ground at about 3 bars, for example, with a difference of 16 bars of pressure being released.

Alternatively, the pod 300 may include a paper filter between the holes 336 and the coffee ground, although not necessary, to allow the beverage to pass while preventing the smaller coffee sediments from passing through during the brewing process. Moreover, it is within the scope of the invention to have the size and number of holes 336 in the base 322 to be independent of the grind size of the beverage ingredient 310, where the size of the holes 336 may be sized to substantially prevent the ingredient sediment from passing through the holes 336.

FIG. 3B shows at least one retainer wall 332 extending from the base 322. In particular, the base 322 may have a plurality of retainer walls 332 extending from that place with layers of retainer walls 332 forming a pathway between two adjacent retainer walls 332, and with a plurality of slits 334 on each of the retainer wall 332, as discussed in more detail below. The retainer walls 332 may have distal ends 335 that contour the shape of the inner side of the base 316 of the container 304.

FIG. 3C shows a cross-sectional view of an assembled pod 300 without the beverage ingredient 310, where the interior of the container 304 may be divided into different chambers, including the cavity 362 that extends outwardly to form the gap 361 between the lid 314 and the base 342 of the distributor as discussed above; and a first chamber 364 and a second chamber 366. The first chamber 364 may be generally defined as the interior space of the filter 306 or the space between the distributor 312 and the second chamber 366. The second chamber, 366, may be generally defined as the space between the filter 306 and the container 304. The cavity 362 may be adapted to receive an inlet member (not shown) from a high or low-pressure brewing mechanism, and the heated water from the inlet may flow along the gap 361 to distribute the heated water in a substantially even manner through the holes 348 to more evenly mix with the beverage ingredient 310 to extract the beverage such as espresso or coffee from the ingredient 310. The base 322 of the filter 306 may be in close approximation to the base 316 of the container 304 to enlarge the first chamber 364 to pack about 6 to 18 grams of coffee ground to brew about 0.8 to about 3 oz of espresso or 6 to 14 oz of coffee. The size and number of holes 336 provided on the base 322 may be predetermined to brew a desired beverage, such as espresso or coffee. The circumference or diameter of the sidewall 324 of the filter 306 may be less than the circumference or diameter of the sidewall 318 of the container 304, such that a pathway 368 may be provided between the two sidewalls 324 and 318 around the circumference of the sidewall 324 of the filter 306.

The pod 300 may be assembled in a variety of ways. For example, the opening 360 of the container 304 may be sized to receive the filter 306 such that the first section 328 may rest upon the rim 320 of the container 304. The first section, 328, may be releasably sealed to the rim 320. The opening 354 of the filter 306, as defined by the first section 328, may receive the beverage ingredient 310 (not shown) and may be tampered with to minimize air pockets within the ingredient 310. The distributor 312 may be placed over the ingredient 310 and substantially enclose the opening 354 of the filter 306. The distributor 312 may have a cavity 362 as defined by the protrusion 344 adapted to receive an inlet member to inject liquid therein. Note that it is within the scope of the invention to have the flap 346 extend upward from the base 342 such that there is a sufficient distance between the lid 314 and the base 342, such that protrusion 344 and cavity 362 may not be needed. The lid 314 may be placed over the first section 328, and a circumference near the outer edge 350 of the lid 314 may be sealed to the first section 328 to seal the ingredient 310 within the pod 300 hermetically. The distributor 312 may have a plurality of ribs (not shown) protruding toward the lid 314 to maintain a gap between the lid 314 and the distributor 312 such that the liquid injected into the cavity 362 may flow along the gap and drain through the holes 348 and mix with the beverage ingredient 310 underneath.

Once the pod 300 is assembled, the lid 314 may represent a proximal end, and the base 316 of container 304 may represent a distal end of the pod 300. The pod 300 may have a first pathway 355 along the distal end of the pod and a second pathway 368 from the distal end to the proximal end of the pod. In particular, the first pathway 355 may be formed between the base 322 of the filter and the base 316 of the container 304, and a second pathway 368 may be formed between the sidewall 324 of the filter and the sidewall 318 of the container. The first pathway 355 may be formed by extending the distal ends 335 of the individual retainer walls 332 from the base 322 such that distal ends 335 may substantially contour the inner side 354 of the base 316 of the container 304, thereby minimizing the gap between the distal ends 335 and the base 316 or have the distal end 335 engage with the base 316 of the container 104. As discussed in more detail below, the individual retainer walls 332 may be spaced apart, thereby forming the first pathways 355 between the adjacent walls 332 with the holes 336 formed in the base 322 along the path between adjacent walls. In particular, the holes 336 may be formed between adjacent walls 332, and the walls 332 may have the slits 334 to allow the first pathways 355 to traverse across from the inner wall to the outer walls, as discussed in more detail below.

The extending ribs 325 may engage with the sidewall 318 of the container 304 to center the filter 306 relative to the container 304. This may allow the assembled pod 300 to substantially maintain the second pathway 368, which is substantially uniform between the two sidewalls 318 and 324 around the circumference of the sidewall 324. The second pathway, 368, may extend from the distal end of the filter to the proximal end of the pod 300. In particular, the sidewall 324 may generally extend upwardly from the base 322 in a taper or expanding manner relative to the longitudinal axis 302, in part to enlarge the size of the first chamber 364 to be able to pack more beverage ingredients. As the sidewall 324 extends upwardly towards the proximal end of the pod 300, the sidewall 324 may extend substantially parallel relative to the longitudinal axis 302 to enlarge a gap 363 between the rim 320 and the sidewall 324 at the proximal end. As discussed in more detail below, the enlarged gap area 363 may slow down the flow of the beverage along the second pathway 368 so that the beverage may drain from the pod more smoothly, thereby minimizing the spattering of the beverage as it drains.

The extending ribs 325 may also engage with the sidewall 318 of the container 304 during the brewing process such that the lateral force applied to the interior side 340 of the sidewall 324 may transfer to the sidewall 318 of the container 304. During the brewing process, the pod 300 may be placed in the brewing chamber (not shown), which includes a holder (not shown) adapted to receive the pod 300. The holder may support the outer contour of the container 304, such as the sidewall 318 and the base 316, which in turn support the sidewall 324 and the retainer walls 332 of the filter 306. This may substantially prevent the filter 306 from deforming along the sidewall 324 and the base 322 due to the internal high pressure within the filter 306, such as when brewing high-pressure beverages like espresso. That is, the extending ribs 325 between the two sidewalls 324 and 318 and the retainer walls 332 between the two bases 322 and 316 may substantially transfer the stress on the filter 306 to the holder in order to substantially maintain the first and second pathways 355 and 368 open. Note that various components of the pod 300 may be assembled in a variety of different orders, and the assembly process is not limited to the Steps discussed above.

FIG. 3D shows the pod 300 in a substantially horizontal position in reference to the gravitational direction g, which may be a brewing position of the pod 300. As discussed in more detail below, during the brewing process, the heated water may be injected into the pod 300 through the lid 314 and into the cavity 362 as indicated by the direction arrow 370; and thereafter, the heated water may flow along the following path within the pod 300: (1) as indicated by the direction arrows 372, the protrusion 344 may redirect the heated water towards the lid 314 or the proximal end; (2) as indicated by the direction arrows 374, the heated water may flow along the gap 361 between the lid 314 and the distributor 312 and exit through the holes 348 in the base 342 of the distributor 312 and mix with the beverage ingredient 310 within the first chamber 364; (3) as indicated by the direction arrows 376, the heated water may extract the beverage from the beverage ingredient 310 and the pressure from the heated water injected into the cavity 362 may direct the beverage towards the distal end 322 of the filter 306; (4) as indicated by the direction arrows 378, the beverage may then pass through the holes 336 on the base 322 and flow along the first pathway 355, as discussed in more detail below; and (5) as indicated by the direction arrows 380, with the pod 300 in the substantially horizontal orientation, the gravity may direct the beverage to flow along the second pathway 368, which may be along the six O'clock position of the pod 300 when viewing the first extension 328 as a face on a clock, and the bottom 382 of the first extension 328 may represent the six O'clock position. Note that it is within the scope of the invention to have the pod in a variety of other orientations rather than on a horizontal orientation, such as facing downwards or upwards, where in the upward position, the pressure within the pod may force the beverage upwards to drain from the gap.

The external ribs 325 may maintain a uniform second pathway 368 such that the pod 300 may be brewed in any rotational orientation about the first extension 328. In other words, the pod may be inserted into a brewing mechanism in any rotational direction since the gap in the second pathway 368 is substantially similar around the circumference of the two sidewalls 318 and 324. As discussed above, the gap 363 between the proximal end of the sidewall 324 and the rim 320 may be enlarged to slow down the flow of beverage near the proximal end so that the beverage may drain more smoothly from the pod 300 via a gap formed between the extension 326 and the rim 320, as discussed in more detail below. Note that the sidewall 324 of the filter 306 may not have holes to substantially direct the beverage to flow towards the distal end 322 of the filter 306 and substantially prevent the beverage from passing through the sidewall 324. However, it is within the scope of the invention to have holes in the sidewall 324, depending on the application. In addition, the distributor 312 may or may not be utilized depending on the application. If the distributor is not utilized, then the heated water from the brewing chamber may be directed toward the beverage ingredient 310.

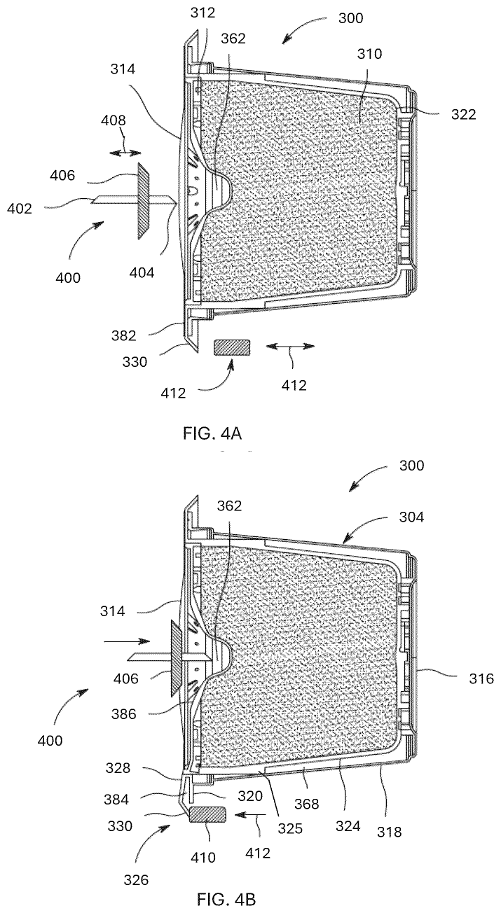

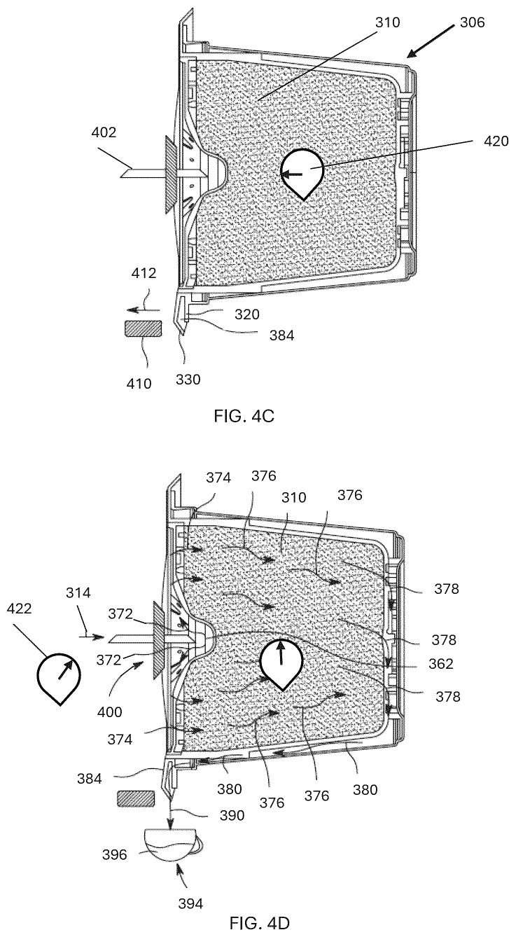

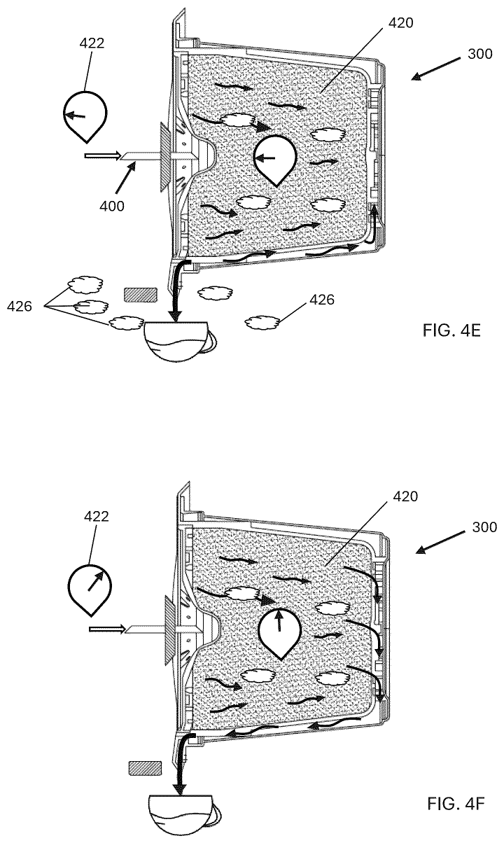

FIGS. 4A through 4F show cross-sectional views of the pod 300 in different stages to illustrate how to brew a beverage with the pod 300. In this example, FIG. 4A shows the pod 300 in a substantially horizontal position or brewing orientation, as discussed above in reference to FIG. 3D, packed with beverage ingredient 310 within the first chamber 364. For example, B-Pod® has two different types of filters: (1) a low-pressure filter and (2) a high-pressure filter. In this example, FIG. 4A describes a low-pressure filter where the beverage ingredient 310 may be coffee ground with an average coffee grind size as the description discussed above in Step 104, referring to FIG. 1, where the beverage ingredient in the brewing chamber has at least 2 bars of pressure after at least 3 oz are brewed. Also, the pressure will depend on the flow rate and the weight of the coffee in the filter. Alternatively, the high-pressure filter may also be used, where there are fewer and fewer holes than the low-pressure filter. In this example, the grind sizes may be coarser and/or of lesser weight than the low-pressure filter.

In the brewing orientation, the pod 300 may be juxtaposed to an inlet member 400 having an inlet end 402 and a tip 404 with a gasket 406 between. The member 400 may be adapted to slide relative to the pod 300 as indicated by the double-ended direction arrow 408, or the pod may be adapted to slide relative to the member 400, or both elements 300 and 400 may be adapted to slide or move relative to each other simultaneously or sequentially. The member 400 may be positioned relative to the pod 300 such that the tip 404 may be juxtaposed to the lid 314 to penetrate the cavity 362 of the distributor 312. The pod 300 may also be juxtaposed to a detached member 410 positions behind the second extension 330 at about six o'clock position 382, as discussed above in reference to FIG. 3D and reference to the gravitational direction g. The detaching member 410 and the pod 300 may be adapted to slide relative to each other as indicated by the double-ended direction arrow 412, where one or both elements 300 and 410 may move relative to each other simultaneously or sequentially.

FIG. 4B shows that to begin the brewing process, the inlet member 400 may pierce, puncture, or cut through the lid 314 or use any other apparatus or method known to one skilled in the art, and the tip 404 may rest within the cavity 362. The gasket 406 may engage with the lid 314 surrounding the member 400 to substantially prevent the water from leaking out of the opening between the member 400 and the lid 314 formed by the punctured hole within the lid. The detaching mechanism 410 may move towards an extended position as indicated by the direction arrow 412 to engage with the second extension 330 to separate the first extension 328 from the rim 320 near the six O'clock position 382, thereby forming a gap 384 between the extension 326 and the rim 320 that may extend from about four O'clock to about eight O'clock positions; and in particular from about five O'clock to about seven O'clock positions. The second section 330 may taper towards the base 316 of the container 304 such that the underside of the second section 330 may form a concave shape or hook to allow the detaching member 410 to engage with the underside of the second section 330 to separate the first extension 328 from the rim 320 more consistently.

FIG. 4B also shows that the diameter of the gasket 406 may be smaller than the diameter of the opening 386, forming the cavity 362 such that the force applied by the gasket 406 onto the lid 314 may not directly transfer to the distributor 312 to minimize the resistance upon the extension 326 to allow the detaching mechanism 410 to separate the first extension 328 from the rim 320 and to substantially maintain the gap 384 opening. The newly formed gap 384 may form a part of the second pathway 368 between the two sidewalls 318 and 324 and also between the adjacent extending ribs 325 to allow the beverage formed within the pod 300 to flow along the second pathway 368 and drain through the gap 384, as discussed in more detail below.

FIG. 4C illustrates that as the detaching member 410 moves further towards the inlet member 400, as indicated by the direction arrow 412, the second extension 330 may flex to allow the detaching member 410 to pass and rest on the opposite side of the extension such that the detaching member 410 may not interfere with the beverage draining out of the gap 384. Once the gap 384 is formed, a combination of the rim 320 and the concave shape of the second extension 330 that extends downwardly may act as a spout to allow the beverage to pour from the gap 384 in a smooth manner to minimize spattering of the beverage. This may provide a clear path for the beverage to drain from the pod 300 without coming into contact with the brewing mechanism to avoid contaminating the beverage, as discussed in more detail below. Note that once the gap 384 is opened, and without the water from the inlet member 400, the pressure in the beverage 310 is about atmospheric pressure, as indicated by the meter 420.

FIG. 4D shows the inlet member 400 injecting heated water 414 into the cavity 362. For the cold beverages, as discussed in Steps 102 and 202, the water temperature from the inlet member 400 may be colder than 140° F., or from 35° F. to 50° F. The water flow rate through the inlet member 400 is relatively high compared to brewing coffee, where the flow rate may be from about 3.75 to about 5.0 grams/second, as indicated by a meter 422. Again, the flow rate may depend on the grind size and the weight of the beverage ingredient. Once the water flow through the pod 306 is established, the pressure in the beverage ingredient may rise, as indicated by the meter 420, where after the 3 oz are brewed, the pressure in the pod 306 is at least 2 bars. About FIG. 3D, the heated water 414 may flow along the path as indicated by the direction arrows 372 and 374. The beverage 396 extracted from the beverage ingredient 310 may flow along the path as indicated by the direction arrows 376, 378, and 380, and drain out of the gap 384 as indicated by the direction arrow 390, and pour the beverage 396 into a mug 394.

FIG. 4E shows the inlet member 400 stops injecting water into the pod 300, which indicates that meters 420 and 422 have low pressures. In referring to Steps 106 and 108, where there is at least 1 oz of brewing the beverage from the last cycle, the water stops for injecting into the pod for at least 2 seconds. As discussed in Step 108, when there are periodic disruptions of injection water through the brewing chamber or pods, the pressure increases more in an exponential manner, where in the beginning, the pressure is low. Near the completion of the brewing cycle, there is high pressure. The hypothesis for why this happens is that when the water injection through the brewing chamber stops or slows down, there is sufficient time to have some of the smaller grind sizes of the beverage ingredients may partially plug the outlet holes, so that there will be a smaller gap to flow the beverage, which will increase the pressure. Also, if the water is stopped in the brewing chamber, this may lead to a vacuum pressure inside the brewing chamber. When this happens, air 426 may go inside the brewing chamber through gap 384, pathways 368 and 355, and chamber 364 to compensate for the vacuum pressure so that air is infused inside the brewing chamber.

FIG. 4F shows the inlet member 400 again injecting water into the pod 300, which indicates that meters 420 and 422 have high pressure. With the next cycle of water injected into the brewing chamber, the beverage outlet may have more air bubbles. Also, with cooler water or a cooler beverage, the air bubbles will more likely be infused within the beverage, thus minimizing evaporation of the air bubbles from the beverage.

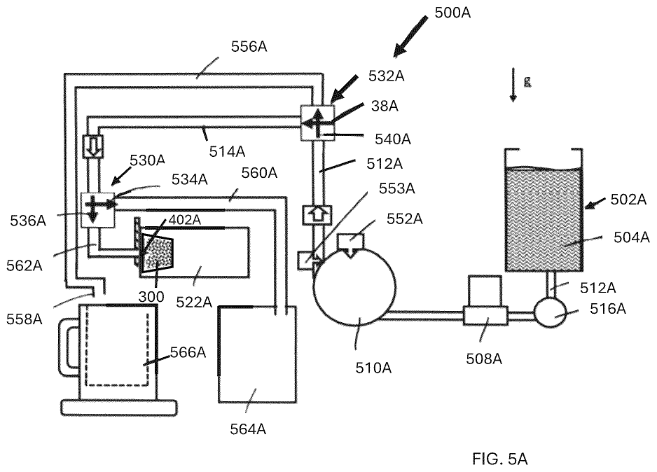

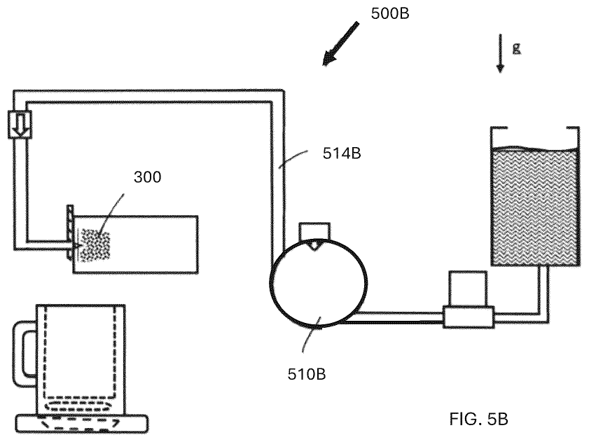

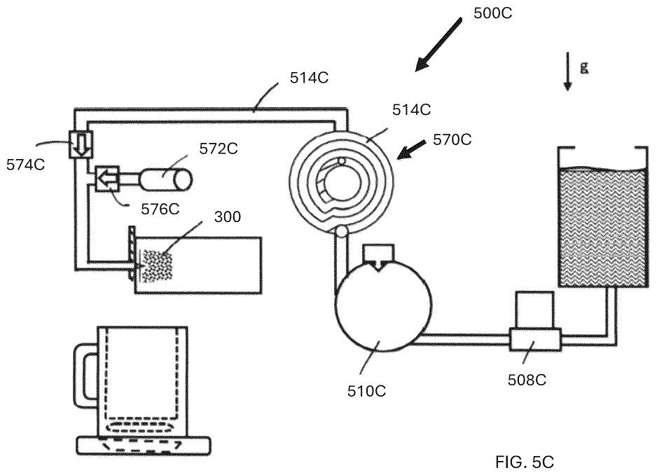

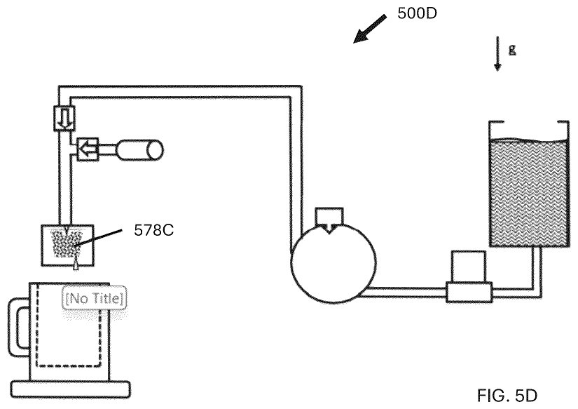

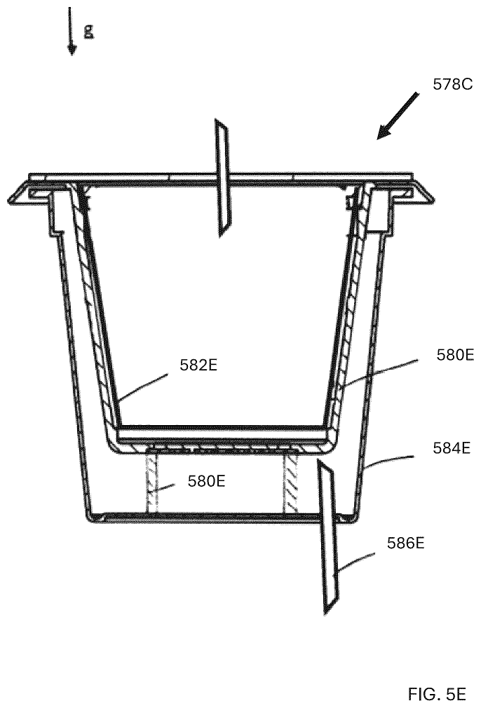

FIGS. 5A through 5D illustrate a single-serve brewing system 500A relative to the gravitational direction configured to adjust the water temperature, brewing time, and beverage-to-water ratio to brew various beverages. The brewing system 500A provides the heated water at a relatively high pressure from about 7 to 15 bars to the brewing chamber 522A with a pod 300 therein, as discussed above in reference to FIGS. 3 and 4. The brewing system 500A may include a water tank 502A sized to hold water 504A therein and a pump 508A to provide the water from the water tank 502A to a heater 510A through a first tube 512A. In addition, a flow meter 516A may be coupled to the first tube 512A to monitor the flow rate of water passing through the first tube when the pump 508A is activated to determine the amount of water provided from the water tank 502A to the heater 510A and drain in the outlet 558 and the needle 402. The brewing system 500A may also include a first switch 532A coupled to the first tube 512A between the heater 510A and the brewing chamber 522A. The first valve 532A may have two channels where the route 538A flows to the tube 514A, which may lead to a second valve 530A. Alternatively the route 540A flows to the tube 556A, which may lead to the outlet 558A, which may pour hot water from the heater 510A. The second valve 530A may have two channels where the route 534A flows to the tube 560A, which may lead to a reservoir 564A. Alternatively, the route 536A flows to the needle 402 to inject water into the pod 300 within the brewing chamber 522, which may pour beverage 390 into the cup 566A.

The brewing chamber 500A may have three options. The first option is to have the first valve 532 have the route 538A, where the water flows to tube 514A, and have the second valve 530 have the route 562A, where the water flows to needle 402 to brew a beverage from the pod 300. The second option is to have the first valve 532 have the route 540A so that the water from the heater 510 flows to the cup 566A. With the second option, some beverages have some percentage of coffee, and the balance is water, such as hot or room temperature. For example, for Americano, where there may be 20% is espresso, and 80% is hot water espresso, the first valve 532A is routed to 538A, and the second valve 530 is routed to 536 to brew espresso, and after the espresso is done, the first valve 532 with a switch to route 540A to pour hot water to the cup.

The third option is if the previous brewing was done with hot beverages just before the cold brew cycle, the heater 510A may have a high temperature initially, so even if the heater is turned OFF, the water temperature may reach over 140° F. initially compared to Steps 102 and 202. It may take about 2 oz of room temperature water to flow through the heater 510A to cool the heater so that the water temperature is lower than 140° F. Under that scenario, before cold brew starts, the second valve 530A may switch to route 534A to flow the hotter water to the reservoir 564A until Steps 102 or 202 are met. After the water temperature is cool enough to meet Steps 102 and 202, the second valve 530A may switch back to the route 536A.

Alternately, the third option is when the brewing cycle of the beverage is done from the pod 300, the second valve 530A switch from the route 536A to route 534A so that the excess pressure within the pod 300 may be released to the needle 402 and back into the tube 562A and flow through the tube 560 and into the reservoir 564A. That is, when the pump 508A stops when the coffee is done from the pod 300, there may be higher pressure within the pod 300 so there may be dripping of coffee. To minimize the dripping, when the second valve 530A switches to route 534A, the pressure of the pod 300 may push the leftover beverage with the pod 300 back to the tubes 562A and 560A and drain into the reservoir so that the dripping is hidden inside the brewer. FIG. 5B shows another embodiment of a single-serve brewing system 500B, where the first option may be implemented for the simpler system than the embodiment of FIG. 5A. That is, the heater 510B routes the water to tube 514B, which injects the water into pod 300.

FIG. 5C shows additional elements to FIG. 5B, where the single-serve brewing system 500C includes a cooler element 570C and an air pump 572C. About implementing Step 202, where the water is cool from 35° F. to 50° F., the brewing system 500C may include a thermoelectric cooler (TEC) juxtaposed to the tube 514C such that powering the TEC can either cool or heat the water within the tube 514C. The TEC may include a temperature sensor that monitors the temperature within the water and a processor that controls the power provided to the TEC to cool the pocket if the measured temperature is above the desired temperature range and heat the pocket if the measured temperature is below the desired temperature range.

The signal system 500C may include the air pump 572C with two one-way valves, 574C and 576C, so that the air provided by the air pump 572C may flow through the pod 300. Introducing the air inside the pod 300 may infuse the bubble flavor into the beverage. The air pump 572C may pump air in the pod 300 when the water pump 508C is turned on or off. For example, the water pump 508C may pause from 1 to 10 seconds for every 0.2 oz to 1.0 oz of the brewing cycle, and during this pause period, the air pump 572C may inject air into the pod 300. In this regard, the brewing systems described in (1) U.S. Pat. No. 11,730,306 issued Aug. 22, 2023, entitled “CONTROLLING BREWING PARAMETERS OF SINGLE-SERVE BEVERAGE SYSTEM”, by Sung Oh; and (2) US Published Patent Application No. 2021/0298514 published Sep. 30, 2021, entitled “SINGLE SERVE BEVERAGE POD”, by Sung Oh, et al., which are hereby incorporated by the two references in their entirety.

FIG. 5D shows another embodiment of a single-serve brewing system 500D, which is similar to the embodiment in FIG. 5C, where the pod 578C may be on a vertical axis similar to K-Cup® pods and without the cooler element 570C. The mechanism of the single-serve brewing system 500D may be similar to the Keurig® brewing system. However, the K-Cup pod uses a paper filter, which may not be able to handle substantial pressure within the pod. That is, in Step 104, the K-Cup® pods may not withstand the pressure of at least 2 bars, as indicated in Step 104. FIG. 5E shows a modification of the K-Cup pods 578C with the addition of support 580E for the filter 582E so that the filter 582E may handle additional pressure within the filter 582E. The support 580E may be between the filter 582E and the outer container 584E so that the coffee may flow through the support 580E with holes in the side wall and exit through the outlet needle 586E. The support 580E may strengthen the filter 582E to allow the K-Cup to handle the pressure of 3 to 8 bars.

While various embodiments of the invention have been described, it will be apparent to those of ordinary skill in the art that many more embodiments and implementations are possible within the scope of this invention. Moreover, various features and functionalities described in this application and Figures may be combined individually and/or in combination of features and functionalities with others. Accordingly, the invention is not to be restricted except in light of the attached claims and their equivalents.

What is claimed is:

1. A matcha beverage composition for use in a single-serve pod, comprising:
(a) 10-45% by weight matcha powder; and
(b) 55-90% by weight tencha;
wherein the tencha is coarser than the matcha powder, that do not substantially affect the taste of the matcha powder when the pod is brewed.

2. The composition of claim 1, wherein the matcha powder in an amount of 15% to 40% by weight, and the tencha is present in an amount of 60% to 85%.

3. The composition of claim 1, wherein the matcha powder in an amount of 20% to 35% by weight, and the tencha is present in an amount of 65% to 80%.

4. A matcha beverage composition for use in a single-serve pod, comprising:
(a) 10-30% by weight matcha powder;
(b) 15-40% by weight tencha; and
(c) 40-70% by weight sugar;
wherein the tencha and sugar are coarser than the matcha powder, which reduces the pressure within the pod when the pod is brewed.

5. The composition of claim 4, wherein the matcha powder in an amount of 15% to 25% by weight, the tencha is present in an amount of 20% to 35%, and sugar is present in an amount of 45% to 55%.

6. The composition of claim 4, wherein the sugar is turbinado sugar.

7. The composition of claim 4, wherein the tencha does not substantially affect the taste of the matcha powder when the pod is brewed.

8. A matcha beverage composition for use in a single-serve pod, comprising:
(a) 2.0 g to 7.0 g of matcha powder;
(b) 5.5 g to 10.0 g of tencha; and
(c) 8.0 g to 14.0 g of sugar;
wherein the tencha and sugar are coarser than the matcha powder, which reduces the pressure within the pod when the pod is brewed.

9. The composition of claim 8, wherein the matcha powder is in an amount of 3.5 g to 5.5 g, the tencha is in an amount of 7.0 g to 9.0 g, and sugar is in an amount of 9.0 g to 13.0 g.

10. The composition of claim 8, wherein the sugar is turbinado sugar.

11. The composition of claim 8, wherein the tencha does not substantially affect the taste of the matcha powder when the pod is brewed.

12. A method of brewing a beverage mixture within a single-serving pod where the beverage mixture has excessive pressure during the brewing process, the method comprising:
providing the beverage mixture where the first ingredient is an underlying beverage and a second ingredient that is coarser than the first ingredient, where the taste of the first ingredient is not substantially impacted by the second ingredient;
inserting the beverage mixture into a single-serve pod;
providing water into the single-serve pod where an average water temperature during the brewing process is greater than 140° F.; and
dividing a serving size of the signal-serve pod into several volume makers, where a flow rate of the first maker is higher than a last marker.

13. The method according to claim 12, further including:
providing a third ingredient into the beverage mixture, where the third ingredient is a sugar,
and the sugar is coarser than the first ingredient.

14. The method according to claim 13, wherein the sugar is a turbinado sugar.

15. The method according to claim 12, where the beverage mixture is a matcha mixture where the first ingredient is matcha powder and the second ingredient is a tencha.

16. The method according to claim 15, further including:
providing a third ingredient into the beverage mixture where the third ingredient is a sugar, where the matcha powder is 2.0 g to 7.0 g, the tencha is 5.5 g to 10.0 g, and the sugar is 8.0 g to 14.0 g.

17. The method according to claim 15, further including:
providing a third ingredient into the beverage mixture, where the third ingredient is a sugar; and
providing (a) 10-30% by weight matcha powder, (b) 15-40% by weight tencha, and (c) 40-70% by weight sugar.

18. The method according to claim 15, where the tencha has a length of about 1.00 mm to about 5.0 mm.

19. The method according to claim 12, further including:
providing steam into the pod after the flow rate of the last marker is finished.

20. The method according to claim 12, further including:
providing a second marker between the first marker and the last marker, where the flow rate of the first marker is higher than the flow rate of the second marker, and the flow rate of the second marker is higher than the flow rate of the last marker.
